(19) United States
(12) Patent Application Publication
(10) Pub. No.: US 2018/0368564 A1
(43) Pub. Date: Dec. 27, 2018

(54) TOOTHBRUSH BASE AND TOOTH BRUSHING MONITORING SYSTEM

(71) Applicant: Hong ZHENG, Kunming, Yunnan Province (CN)

(72) Inventor: Hong ZHENG, Kunming, Yunnan Province (CN)

(21) Appl. No.: 16/063,159

(22) PCT Filed: Nov. 14, 2016
(86) PCT No.: PCT/CN2016/105725

§ 371 Date: Jun. 15, 2018

(30) Foreign Application Priority Data
Dec. 20, 2015 (CN) 201521062738.7

(51) Int. Cl. A46B 15/00; A61C 17/22

(52) U.S. Cl. CPC A46B 15/0008; A46B 2200/1066; A46B 15/0038; A61C 17/221

(57) ABSTRACT

The present disclosure discloses a toothbrush base and a toothbrushing monitoring system. The toothbrush base is suitable for connecting to a toothbrush for monitoring a toothbrushing process of a user. And the toothbrush base further provides analytical data for an external terminal device. The toothbrushing monitoring system includes the toothbrush base. A technical solution adopted in the present disclosure is: a toothbrush base, suitable for connecting to a toothbrush for collecting data during a toothbrushing process of a user. The toothbrush base comprises a housing. The housing is provided with a connecting end connected to an external toothbrush. The toothbrush base further comprises a toothbrushing monitoring device in the housing. The toothbrushing monitoring device is configured for collecting toothbrushing process data.

### TECHNICAL FIELD

The present disclosure relates to dental medical equipment, particularly to a toothbrush base and a toothbrushing monitoring system for monitoring a toothbrushing process of a user.

### BACKGROUND

Toothbrushing is an important way of dental self-care for people to keep cavity clean by removing dental plague, soft mucinous deposits and food residues. However, most people take toothbrushing as a routine in daily life without taking it seriously. Or maybe even their toothbrushing method is not correct. These lead to dental health problems such as damaged enamel and tooth decay. Given that China is still in the primary stage in dental health education, monitoring during toothbrushing is urgently needed in the society to properly teach people how to brush teeth.

### SUMMARY

According to disadvantages of prior art, a technical problem to be solved in the present disclosure is to provide a toothbrush base. The toothbrush base is suitable for connecting to a toothbrush for monitoring a toothbrushing process of a user. And the toothbrush base further provides analytical data for an external terminal device.

According to disadvantages of prior art, another technical problem to be solved in the present disclosure is to provide a toothbrushing monitoring system. The toothbrushing monitoring system monitors a toothbrushing process of a user and judges whether postures are correct or not.

To solve the above-mentioned technical problems, a technical solution adopted in the present disclosure is: a toothbrush base, suitable for connecting to a toothbrush for collecting data during a toothbrushing process of a user. The toothbrush base includes a housing. The housing is provided with a connecting end connected to an external toothbrush. The toothbrush base further includes a toothbrushing monitoring device in the housing. The toothbrushing monitoring device is configured for collecting toothbrushing process data.

Preferably, in the technical solution, the connecting end is provided with a plug-in structure or a thread structure or a clamp structure or a magnetic attraction structure to match the external toothbrush.

Preferably, in the technical solution, the housing is comprised of two segments, the two segments are connected to each other through a plug-in structure or a thread structure or a clamp structure or a magnetic attraction structure, the connecting end is arranged at one of the two segments, and the toothbrushing monitoring device is arranged at the other of the two segments.

Preferably, in the technical solution, a periphery of the toothbrushing monitoring device is provided with a waterproof casing to prevent external liquid from coming in.

Preferably, in the technical solution, the housing wraps around a periphery of the toothbrush monitoring device to prevent external liquid drops from coming into the toothbrush monitoring device.

Preferably, in the technical solution, the connecting end is made of a flexible material, and the flexible material is easy to deform so as to connect to the toothbrush.

Preferably, in the technical solution, the flexible material is rubber material or silicone material.

Preferably, in the technical solution, the toothbrushing monitoring device includes: a power input end configured for electrically connecting with a power supply; a sensor configured for monitoring toothbrushing process data, the toothbrushing process data including a toothbrushing movement track and/or brushing times in a certain area and/or a brushing force; a data exchanger configured for connecting with an external terminal device and transferring the toothbrushing process data to the external terminal device for comparative analyses; and a controller electrically connecting with all components, the controller being configured for controlling operation of each component.

Preferably, in the technical solution the toothbrush base further comprises a power supply, the power supply is electrically connected to the power input end and thus supplies power for the toothbrushing monitoring device.

Preferably, in the technical solution the data exchanger comprises a wireless transmitting-receiving element.

Preferably, in the technical solution the wireless transmitting-receiving element uses low-power Bluetooth.

Preferably, in the technical solution the sensor comprises an acceleration sensor and a gyroscope, the acceleration sensor is configured for detecting linear acceleration data during the toothbrushing process of the user, and the gyroscope is configured for detecting gradient data during a toothbrushing process of the user.

Preferably, in the technical solution the acceleration sensor is a 3-axis acceleration sensor.

Preferably, in the technical solution the sensor further comprises a timer, which is configured for calculating duration of the toothbrushing process of the user.

Preferably, in the technical solution the sensor further comprises a counter, which is configured for counting the number of times of brushing in each area during the toothbrushing process.

Preferably, in the technical solution the toothbrush base further comprises an output element for a user, the output element comprises a display element or/and a voice output module or/and a speaker or/and a vibration motor or/and an LED indicator.

Preferably, in the technical solution the toothbrushing monitoring device further comprises a timing element, the timing element is configured for controlling operation of the output element according to time the user sets, thus reminding the user to brush teeth on time.

Preferably, in the technical solution the toothbrushing monitoring device further comprises a storage, the storage is configured for storing data detected by the sensor.

Preferably, in the technical solution the toothbrushing monitoring device further comprises a comparator and an output element, the storage stores a comparison table of reference ranges corresponding to all data, the comparator is configured for making comparative analyses by comparing data from the toothbrushing monitoring device with the comparison table to output a conclusion as to whether the toothbrushing of the user is correct or not, and the output element is configured for outputting the conclusion to the user.

Another technical solution disclosed in the present disclosure is a toothbrushing monitoring system, the toothbrushing monitoring system comprises a terminal device, and a toothbrush base having a toothbrushing monitoring device. The terminal device is suitable for exchanging data with the toothbrushing monitoring device, the toothbrush base comprises a housing, the housing is provided with a connecting end connected with an external toothbrush, the toothbrush base is further provided with a toothbrushing monitoring device in the housing for collecting data during the toothbrushing process of the user; the terminal device stores comparison tables of reference ranges corresponding to all data, the terminal device is configured for making comparative analyses with the data provided by the toothbrushing monitoring device and the comparison tables, according to analytical results the terminal device is further configured for giving a judging conclusion as to whether the toothbrushing of the user is correct or not.

Preferably, in the technical solution the terminal device is a mobile terminal device.

Preferably, in the technical solution the mobile terminal device is a cell phone or a tablet computer or a notebook computer.

Preferably, in the technical solution a user can send a control command to the toothbrushing monitoring device through the terminal device so as to control operation of the toothbrushing monitoring device.

Preferably, in the technical solution the terminal device further comprises a teaching mode unit for teaching the user how to brush teeth correctly.

Preferably, in the technical solution the toothbrushing monitoring system further comprises a cloud server, the cloud server is configured for storing data or the judging conclusion from the toothbrushing monitoring device so that guardians or doctors or other natural persons can provide toothbrushing information of the user.

Advantages of the invention are: since the toothbrush base in the invention features the function of monitoring data of a toothbrushing process of a user. The data includes a toothbrushing movement track and/or brushing times in a certain area and/or a brushing force. All the data can be used as essential parameters for analyzing whether the toothbrushing process of the user is correct or not. All the data has also an advantage of providing analytical data for an external terminal device. Moreover, the toothbrush base in the present disclosure is coupled with the toothbrush in a detachable way, which makes it easy for a user to change a toothbrush in daily life.

The toothbrushing monitoring system in the present disclosure plays a role in oral health education because the toothbrushing monitoring system has the function of monitoring a toothbrushing process of a user and analyzing the toothbrushing process. The toothbrushing monitoring system then makes a judgment as to whether the toothbrushing process is correct or not and outputs the judgment conclusion to remind the user.

Other advantages of the present disclosure will be further illustrated in the detailed description of the preferred embodiments.

### BRIEF DESCRIPTION OF THE DRAWINGS

FIG. 1 is a perspective view of a toothbrush base of the present disclosure.

FIG. 2 is a cross-sectional view of the toothbrush base of the present disclosure.

FIG. 3 is a schematic exploded structural view of the toothbrush base of the present disclosure.

FIG. 4 is a schematic structural view of a toothbrushing monitoring device of the present disclosure.

FIG. 5 is a block diagram of the toothbrushing monitoring device of the present disclosure.

FIG. 6 is a schematic structural view of the toothbrush base coupling with a toothbrush of the present disclosure.

FIG. 7 is a cross-sectional view of a toothbrush base according to another embodiment of the present disclosure.

FIG. 8 is a block diagram of a toothbrushing monitoring system of the present disclosure.

FIG. 9 is a block diagram of a toothbrushing monitoring device according to another embodiment of the present disclosure.

### DETAILED DESCRIPTION

To better illustrate the technical problem, the technical solutions and advantages of the present disclosure, embodiments will now be described in detail below with references to the drawings. It is to be understood that the preferred embodiments described in this part is only to be considered as illustrating the present disclosure instead of to be considered as limiting the scope of the present disclosure.

### The First Embodiment

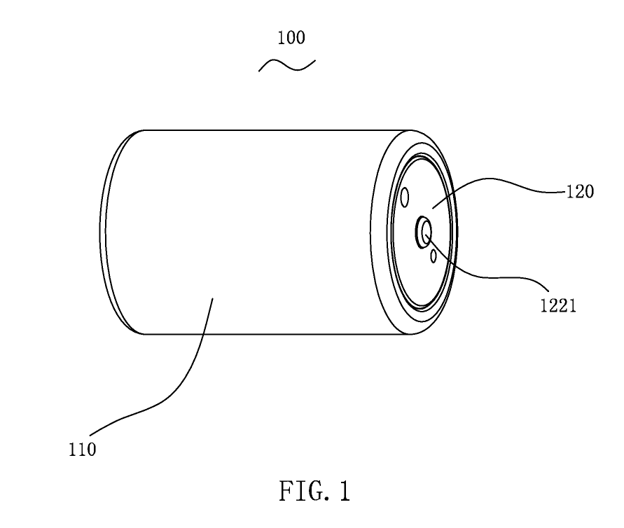

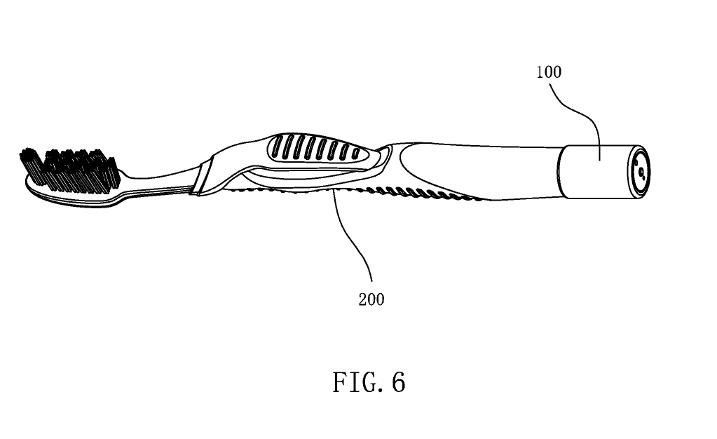

Referring to FIGS. 1, 2, 3 and 6, a structural view in accordance with a first preferred embodiment is provided. The embodiment discloses a toothbrush base 100. The toothbrush base 100 is suitable for connecting to a toothbrush 200 and collecting data during a toothbrushing process of a user. The toothbrush 200 has a housing 110, and the housing 110 includes a connecting end 111 to be connected to the external toothbrush 200. The toothbrush base further has a toothbrushing monitoring device 130 and a power supply 140 inside the housing. The toothbrushing monitoring device 130 is configured for collecting data during a toothbrushing process of a user. And the power supply 140 is configured for supplying power for the toothbrush monitoring device 130.

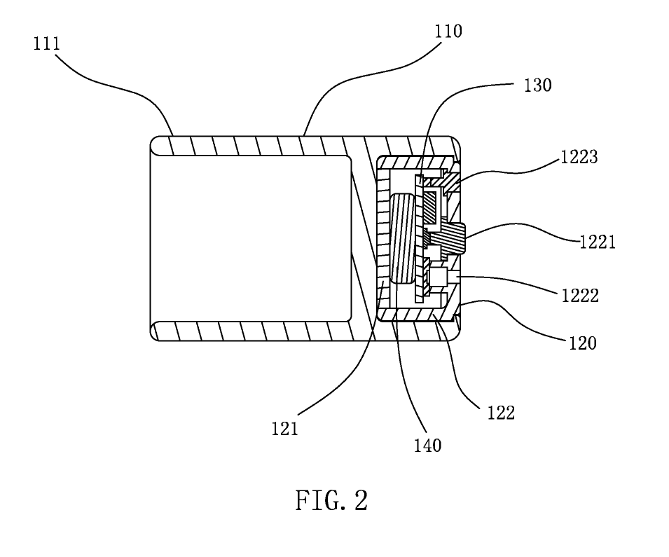

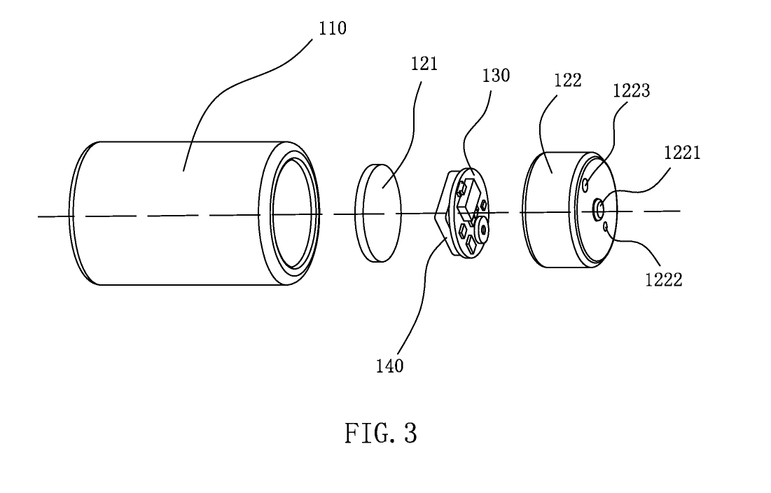

Also referring to FIGS. 2 and 3, the periphery of the toothbrushing monitoring device 130 is provided with a waterproof casing 120 to prevent external liquid from coming in.

In this embodiment, for easy assembly, the waterproof casing 120 includes a wrapping casing 122 and a sealing cap 121. The wrapping casing 122 and the sealing cap 121 can be separated from each other to take out or put in the toothbrushing monitoring device 130. In other embodiments, when there is not a configuration of the waterproof casing 120, the housing 110 is capable of directly wrapping the periphery of the toothbrushing monitoring device 130 to prevent external liquid drops from coming into the toothbrushing monitoring device 130.

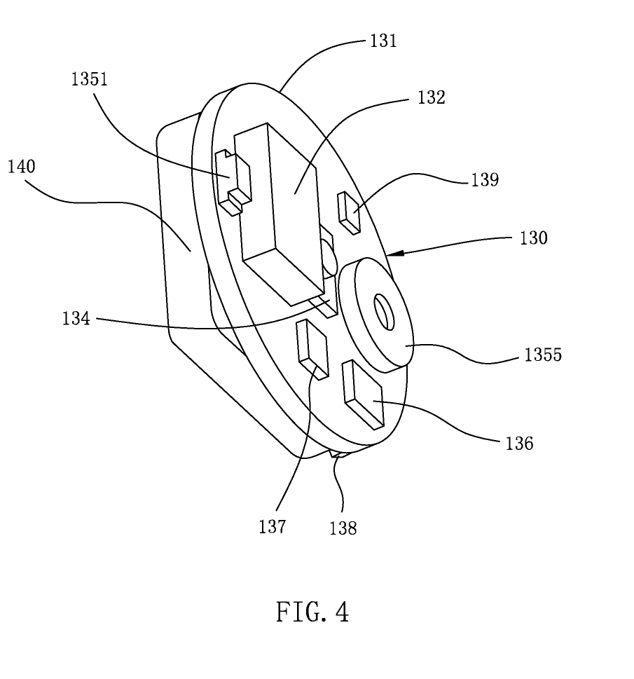

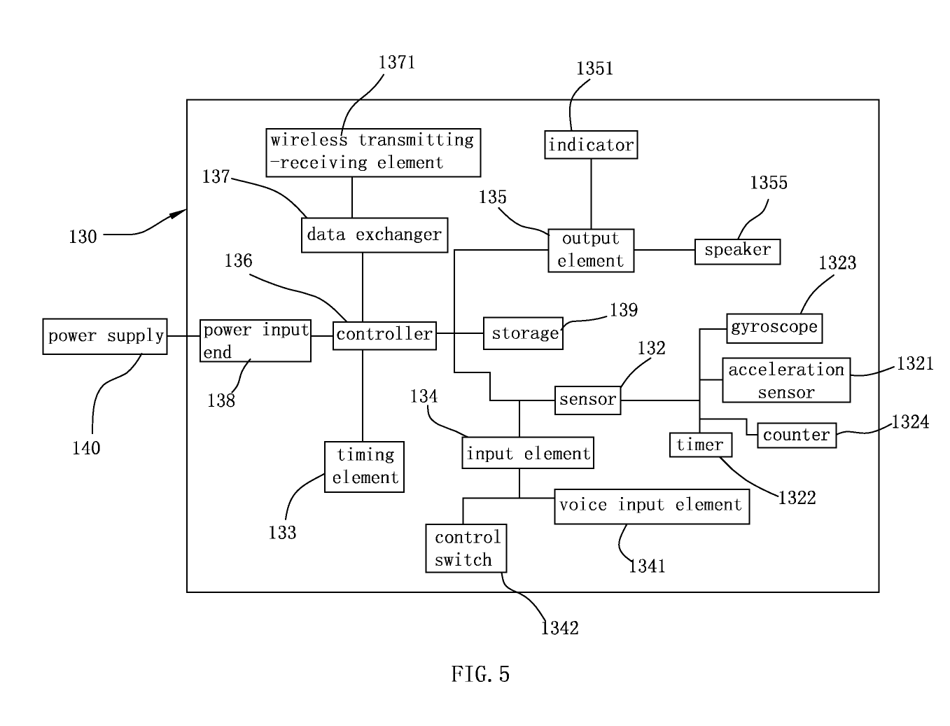

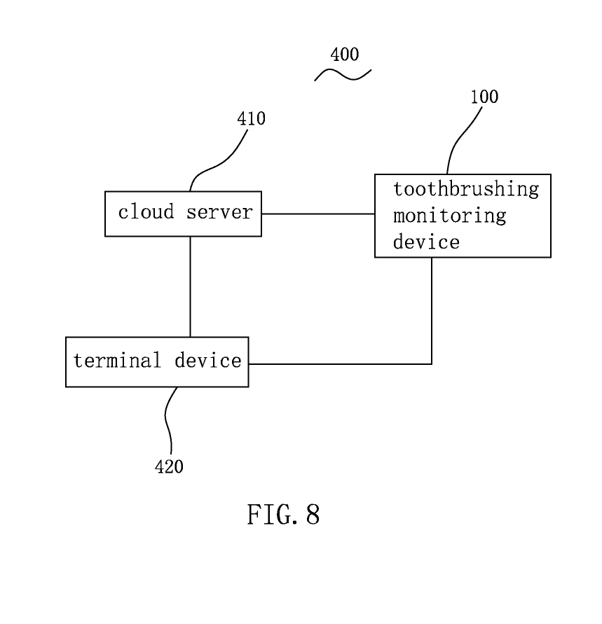

Referring to FIGS. 4 and 5, the toothbrushing monitoring device 130 is configured for detecting data during a toothbrushing process of a user. An external terminal device 420 uses the data to analyze whether the toothbrushing process is correct or not (please refer to FIG. 8). The toothbrushing monitoring 130 includes a PCB 131, the PCB 131 having a power input end 138, a sensor 132, a controller 136 and a data exchanger 137. The power input end 138 is configured for electrically connecting the power supply 140 to supply power for the toothbrushing monitoring device 130; the sensor 132 is configured for detecting data during a toothbrushing process of the user, the data including a toothbrushing movement track, brushing times in a certain area, a brushing force and duration of a brushing process; the controller 136 is configured for electrically connecting with all components to control operation of all components; the data exchanger 137 is configured for connecting with the external terminal device 420 to transfer the received data to the external terminal device 420 for comparative analyses. In this embodiment, the data exchanger 137 includes a wireless transmitting-receiving element 1371. The wireless transmitting-receiving element 1371 uses low-power Bluetooth.

Referring to FIG. 5, in this embodiment, the sensor 132 includes an acceleration sensor 1321, a timer 1322, a gyroscope 1323 and a counter 1324. The acceleration sensor 1321 is configured for detecting a linear acceleration of the toothbrush 200 during a toothbrushing process of a user. The gyroscope 1323 is configured for detecting a gradient of the toothbrush 200 during a toothbrushing process of a user and the controller 136 is configured for calculating a toothbrushing movement track, brushing times in a certain area and a brushing force. The timer 1322 is configured for calculating duration of a toothbrushing process. Duration of a toothbrushing process can be time of a whole toothbrushing process or time used to brush a certain area. The counter 1324 is configured for counting brushing times in each area. In this embodiment, the acceleration sensor 1321 is a 3-axis acceleration sensor. In other embodiments, the sensor 132 can be a 6-axis sensor integrating the acceleration sensor 1321 and the gyroscope 1323 or a 9-axis sensor integrating the acceleration sensor 1321, the gyroscope 1323 and a geomagnetic sensor. A toothbrushing movement track analysis function can refer to the swing movement track detecting function by a sensor in a golf swing analysis instrument.

Also referring to FIG. 5, the toothbrushing monitoring device 130 is further provided with an output element 135 to output information for users. In this embodiment, the output element 135 includes an LED indicator 1351 and a speaker 1355. Through color changing and flashing speed, the indicator 1351 can indicate power information of the toothbrushing monitoring device 130, or the connection status with the external terminal device 420, or turning on, or turning off, or reminding to change an toothbrush, or reminding toothbrushing duration. Specifically, take an example, when the indicator 1351 is green, it means that the toothbrushing monitoring device 130 has a normal power supply, while when the indicator 1352 is red, it means that the toothbrushing monitoring device 130 has a low power supply. When the indicator 1351 is green without flashing, it means that the toothbrushing monitoring device 130 is properly connected with the external terminal device 420, while when the indicator 1351 is green with flashing, it means that the toothbrushing monitoring device 130 is not connected with the external terminal device 420 or the toothbrushing monitoring device 130 is not properly connected with the external terminal device 420. The indicator 1351 is green when the toothbrushing monitoring device 130 is on, and the indicator is red when the toothbrushing monitoring device 130 is off. When the timer 1322 finds that a toothbrush has been in use for 3 months, the indicator 1351 turns purple to remind the user to change an toothbrush; when duration of a toothbrushing exceeds a certain value (for example 3 minutes), the indicator 1351 is yellow with flashing to remind the user. The toothbrushing monitoring device 130 further includes a timing element 133. The timing element 133 is configured for controlling the operation of the output element 135 according to settings of a user so as to remind the user to brush teeth on time. The timing element 133 is integrated with the speaker 1355. The timing element 133 can be the commonly used clock chip of prior art.

Referring to FIGS. 4 and 5, the toothbrushing monitoring device 130 further includes an input element 134 and a storage 139. The input element 134 is configured for inputting data into the toothbrushing monitoring device 130. Thus, the user can interact with the toothbrushing monitoring device 130. The storage 139 is configured for storing data detected by the sensor 132. In this embodiment, the input element 134 is a control switch 1342. In other embodiments, the input element 134 can further include a voice input element 1341. Also referring to FIGS. 2 and 3, the surface of the wrapping casing 122 is provided with a button 1221, a pore 1222 and a transparent part 1223. The button 1221 is connected with the control switch 1342, the pore 1222 is communicated with the speaker 1355 and the transparent part 1223 is configured for transmitting light from the indicator 1351.

In this embodiment, a connecting end 111 is made of a flexible material, easy to deform so as to connect with the toothbrush 20. The flexible material is preferably food-grade rubber material or silicon material. In other embodiments, the connecting end 111 can also be configured as a plug-in structure or a thread structure or a clamp structure to connect with the external toothbrush 200.

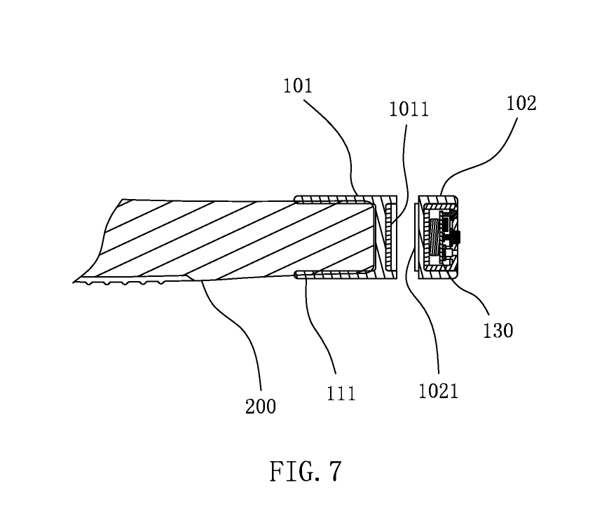

As another embodiment of the present disclosure, referring to FIG. 7, a housing 110 consists of two segments 101, 102. The segment 101 and the segment 102 are integrated through a plug-in structure or a thread structure of a clamp structure or magnetic attraction structure. The connecting end 111 is disposed at the segment 101, while the toothbrush monitoring device 130 is arranged at the segment 102. In this embodiment, the segment 101, having the connecting end 111, is provided with a magnetizable object 1011, while the segment 102, having the toothbrush monitoring device 130, is provided with a magnet 1021. The segment 101 and the segment 102 are connected to each other through a magnetic attraction structure in a detachable way.

### The Second Embodiment

Referring to FIG. 8, a toothbrushing monitoring system 400, according to the present embodiment, includes a terminal device 420, a toothbrush base 100. The toothbrush base 100 includes a toothbrushing monitoring device 130. The terminal device 420 is suitable for wirelessly communicating with the toothbrushing monitoring device 130 for exchanging data. The toothbrush base 100 is the same toothbrush base 100 in the first embodiment. The terminal device 420 stores comparison tables of reference ranges corresponding to all data. And the terminal device 420 is configured for making comparative analyses with the data provided by the toothbrushing monitoring device 130 and the comparison table. Then according to the analyzing result, the terminal device 420 outputs a conclusion as to whether a toothbrushing of a user is correct or not. The user can send a control command to the toothbrushing monitoring device 130 through the terminal device 420 so as to control the operation of the toothbrushing monitoring device 130. For example, the user may send some monitoring modifying data commands to the toothbrush monitoring device 130. In the present embodiment, the terminal device 420 is a mobile terminal device and the mobile terminal device is preferably a cell phone or a tablet computer or a notebook computer.

In this embodiment, judging conclusion is indicated as a score. Specifically, comparison tables consist of reference ranges of each data under correct toothbrushing methods. The terminal device 420 makes comparative analyses between data provided by the toothbrushing monitoring device 130 and the comparison tables. According to the analyzing result, the terminal device 420 outputs a score of the toothbrushing of the user. The following methods may be referred to for setting of reference values of each reference range in the comparison tables: reference values of three reference ranges of a toothbrushing movement track are preset. When the movement track of the toothbrushing monitoring device 130 is within reference values of the first reference range, the score is 3. When the movement track of the toothbrushing monitoring device 130 is within reference values of the second reference range, the score is 2. When the movement track of the toothbrushing monitoring device 130 is within reference values of the third reference range, the score is 1. Likewise, brushing times in a certain area is provided with reference values of three reference ranges. A toothbrushing force is provided with reference values of three reference ranges. Toothbrushing duration is provided with reference values of three reference ranges. Finally, all scores add up to a total score.

The terminal device 420 stores a second comparison table of each data under correct toothbrushing methods during a certain period. When the terminal device 420 or the timer 1322 detects that a certain period ends, the terminal device 420 makes comparative analyses between data of a toothbrushing period provided by the toothbrushing monitoring device 130 and the second comparison table. Then, according to the analyzing result, the terminal device 420 gives the user a score of the toothbrushing period. Specific comparing principles are as the above description of the first comparison table. Reference values of three reference ranges of a toothbrushing movement track are preset in the second comparison table. When the movement track of a certain period provided by the toothbrushing monitoring device 130 is within reference values of the first reference range, the score is 3. When the movement track of a certain period provided by the toothbrushing monitoring device 130 is within reference values of the second reference range, the score is 2. When the movement track of a certain period provided by the toothbrushing monitoring device 130 is within reference values of the third reference range, the score is 1. Likewise, brushing times in a certain area is provided with reference values of three reference ranges. A toothbrushing force is provided with reference values of three reference ranges. Toothbrushing duration is provided with reference values of three reference ranges. Finally, all scores add up to a total score.

The terminal device 420 is provided with a teaching mode unit to teach a user correct toothbrushing methods. When any data of the toothbrushing process is out of the reference ranges, the terminal device 420 will also outputs reminder of improper toothbrushing to the user.

The terminal device 420 stores a third comparison table of suggestions to scores within each range. The terminal device 420 chooses a corresponding suggestion according to the total score and gives the user suggestions on toothbrushing performance. For example, the terminal device 420 gives reminder on incorrect toothbrushing movement track, too much toothbrushing force, and actual toothbrushing times and toothbrushing duration in a certain area. And for reference of the user, the terminal device 420 gives suggestions on correct toothbrushing movement track, recommended brushing times in a certain area, proper toothbrushing force, and recommended toothbrushing duration. The teaching mode unit is activated, when necessary, to teach the user correct toothbrushing methods.

The toothbrushing monitoring system 400 can further include a cloud server 410. The cloud server 410 is configured for storing data provided by the toothbrushing monitoring device 130 or for storing judging conclusion by the terminal device 420 so that guardians or doctors or other natural persons can provide toothbrushing information of the user and the user may easily share toothbrushing habits with others.

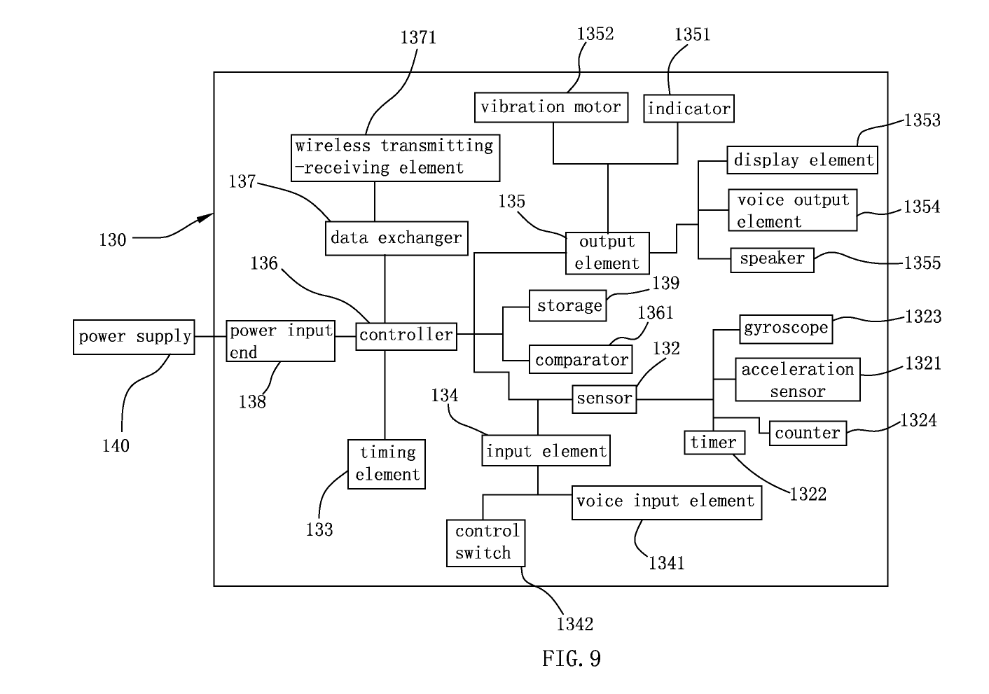

As another embodiment of the present disclosure, the conclusion as to whether a toothbrushing process of a user is correct or not, can also be directly made by the toothbrushing monitoring device 100. Specifically, referring to FIG. 9, this embodiment provides a toothbrushing monitoring device 100 different from the toothbrushing monitoring device in the first embodiment. The toothbrushing monitoring device 100 in this embodiment includes a power input end 138 configured for electrically connecting with a power supply 140; a sensor 132 configured for detecting data during the toothbrushing process of the user, including a toothbrushing movement track and/or toothbrushing times in a certain area and/or toothbrushing force; a storage 139 configured for storing data detected by the sensor 132 and for storing comparison tables of reference ranges of all data; a controller 136 configured for controlling operation of all components; a comparator 1361 integrated in the controller 136 and configured for making comparative analyses between data provided by the toothbrushing monitoring device 130 and the comparison table and then outputting a judging conclusion as to whether the toothbrushing methods of the user are correct or not; an output element 134 configured for outputting the judging conclusion to the user. Aside from what described in the first embodiment, the output element 134 can also be a display element 1353 or/and a voice output element 1354 or/and a vibration motor 1352. The display element 1353 can be a display screen.

Principles and embodiments of the invention have been described for the purpose of illustration based on specific cases, it is to be understood that the above-described embodiments are intended to illustrate rather than limit the disclosure. To those of ordinary skill of the art, according to the spirit of the invention, any slight modifications or equivalent substitution of the structure or configuration of the present disclosure are within scope of the disclosure.

1. A toothbrush base, suitable for connecting to a toothbrush to collect data during a toothbrushing process of a user, the toothbrush base comprising:
a housing, the housing being provided with a connecting end connected to an external toothbrush, wherein the toothbrush base further comprises a toothbrushing monitoring device in the housing, the toothbrushing monitoring device is configured for collecting toothbrushing process data.

2. The toothbrush base of claim 1, wherein the connecting end is provided with a plug-in structure or a thread structure or a clamp structure or a magnetic attraction structure to match the external toothbrush.

3. The toothbrush base of claim 1, wherein the housing is comprised of two segments, the two segments are connected to each other through a plug-in structure or a thread structure or a clamp structure or a magnetic attraction structure, the connecting end is arranged at one of the two segments, and the toothbrush monitoring device is arranged at the other of the two segments.

4. The toothbrush base of claim 1, wherein a periphery of the toothbrushing monitoring device is provided with a waterproof casing to prevent external liquid from coming in.

5. The toothbrush base of claim 1, wherein the housing wraps around a periphery of the toothbrush monitoring device to prevent external liquid drops from coming into the toothbrush monitoring device.

6. The toothbrush base of claim 1, wherein the connecting end is made of a flexible material, and the flexible material is easy to deform so as to connect to the toothbrush.

7. (canceled)

8. The toothbrush base of claim 1, wherein the toothbrushing monitoring device comprises: a power input end for electrically connecting with a power supply; a sensor configured for monitoring toothbrushing process data, the toothbrushing process data including a toothbrushing movement track and/or brushing times in a certain area and/or a brushing force; a data exchanger configured for connecting with an external terminal device and transferring the toothbrushing process data to the external terminal device for comparative analyses; and a controller electrically connecting with all components, the controller being configured for controlling operation of each component.

9. (canceled)

10. The toothbrush base of claim 8, wherein the data exchanger comprises a wireless transmitting-receiving element.

11. (canceled)

12. The toothbrush base of claim 8, wherein the sensor comprises an acceleration sensor and a gyroscope, the acceleration sensor is configured for detecting linear acceleration data during the toothbrushing process of the user, and the gyroscope is configured for detecting gradient data during a toothbrushing process of the user.

13. (canceled)

14. The toothbrush base of claim 8, wherein the sensor further comprises a timer, the timer is configured for calculating duration of the toothbrushing process of the user.

15. The toothbrush base of claim 8, wherein the sensor further comprises a counter, the counter is configured for counting the number of times of brushing in each area during the toothbrushing process.

16. The toothbrush base of claim 8, wherein the toothbrush base further comprises an output element for a user, the output element comprises a display element or/and a voice output module or/and a speaker or/and a vibration motor or/and an LED indicator.

17. The toothbrush base of claim 16, wherein the toothbrushing monitoring device further comprises a timing element, the timing element is configured for controlling operation of the output element according to time the user sets, thus reminding the user to brush teeth on time.

18. The toothbrush base of claim 8, wherein the toothbrushing monitoring device further comprises a storage, the storage is configured for storing data detected by the sensor.

19. The toothbrush base of claim 18, wherein the toothbrushing monitoring device further comprises a comparator and an output element, the storage stores a comparison table of reference ranges corresponding to all data, the comparator is configured for making comparative analyses by comparing data from the toothbrushing monitoring device with the comparison table to output a conclusion as to whether the toothbrushing of the user is correct or not, and the output element is configured for outputting the conclusion to the user.

20. A toothbrushing monitoring system, comprising:
a terminal device; and
a toothbrush base having a toothbrushing monitoring device,
wherein the terminal device is suitable for exchanging data with the toothbrushing monitoring device, the toothbrush base is the toothbrush base according to claim 1, the terminal device stores comparison tables of reference ranges corresponding to all data, the terminal device is configured for making comparative analyses with the data provided by the toothbrush base and the comparison tables, and the terminal device is further configured for giving a judging conclusion as to whether toothbrushing of a user is correct or not according to analyzing result.

21. The toothbrushing monitoring system of claim 20, wherein the terminal device is a mobile terminal device.

22. (canceled)

23. The toothbrushing monitoring system of claim 20, wherein a user can send a control command to the toothbrush base through the terminal device so as to control operation of the toothbrushing monitoring device.

24. The toothbrushing monitoring system of claim 20, wherein the terminal device further comprises a teaching mode unit for teaching the user how to brush teeth correctly.

25. The toothbrushing monitoring system of claim 20, wherein the toothbrushing monitoring system further comprises a cloud server, the cloud server is configured for storing data or the judging conclusion from the toothbrushing monitoring device so that guardians or doctors or other natural persons can provide toothbrushing information of the user.
